(19) United States
(12) Patent Application Publication
(10) Pub. No.: US 2007/0133781 A1
(43) Pub. Date: Jun. 14, 2007

(54) METHOD AND SYSTEM FOR AUTOMATIC ASSIGNMENT OF WORK UNITS TO AGENTS

(76) Inventors: BARBARA FEBONIO, Roma (IT); Sandro Piccinini, Roma (IT)

Correspondence Address: IBM CORPORATION;INTELLECTUAL PROPERTY LAW, 11400 BURNET ROAD, AUSTIN, TX, 78758, US

(21) Appl. No.: 11/566,358

(22) Filed: Dec. 4, 2006

(30) Foreign Application Priority Data
Dec. 12, 2005 (EP) 05111960.0

(51) Int. Cl. H04M 3/00; H04M 5/00

(52) U.S. Cl. 379/265.05

(57) ABSTRACT

A method for the automatic assignment of a work unit to one of at least two agents for the execution thereof, comprising: assigning to the work unit a first attribute describing ranking of the work units; real-time calculating a current workloads of the agents, wherein said calculating is based on a number of work units currently assigned to the agents and on the respective ranking; and assigning the work unit based on the calculated current workloads of the at least two agents.

### TECHNICAL FIELD

The present invention generally relates to the field of electronic data processing, and more particularly to the field of automation of tasks by using data processing systems. Specifically, the invention concerns a method, and a related system, for automating the process of assigning work units to agents responsible of the work unit execution in a generalized call center.

### BACKGROUND ART

More and more often, the relationships with the customers, such as the after-sale maintenance or technical support in respect of the most diverse products are set up by means of call centers, which the customer has to apply to in case of problems, troubles, questions, without having to personally go to a sale or maintenance point. The customer calls the call center, a call center operator attends the call, and, based on the contingent requests of the customer (at least in case the request is non-trivial), a Problem Management Request (hereinafter, “PMR”) is opened; in order for the PMR to be served, it has to be assigned for execution to one of a plurality of agents, typically technically-skilled operators.

In alternative, or in combination to call centers with operators attending to telephone calls from customers, electronic-mail or other communication means may be exploited for receiving the PMRs from the customers. For example, the customer, instead of placing a phone call to the call center, may compile and send an e-mail message to a specific e-mail address, or, using a mobile phone, he/she may send an SMS to a predetermined number. In some cases, specific of software products, when a certain software tool produces unexpected errors while operating on a customer data processing system, an error log may be automatically generated and sent over the Internet to e.g. a server machine of the software producer/vendor/distributor.

Irrespective of the specific way requests for service are sent and received, a call center has in general to manage a flow of incoming PMRs. Managing a PMR means first of all assigning the PMR to the correct agent, who will thereafter take care of the resolution thereof.

Conventionally, the assignment of PMRs to agents is done manually, or in some cases the incoming PMRs are simply put into a queue, and the agents themselves have to select the PMRs waiting to be served in the queue.

EP 1 119 170 discloses a multi-variable work assignment process for assigning work items, such as voice calls, e-mails and other communications or tasks, to agents in a call center. The multi-variable work assignment process determines whether values of a particular variable characterizing the work items fall within a designated range, and if so utilizes at least one additional variable for making the work assignment decision. The work assignment process may also or alternatively consider a weighted combination of multiple variables in making the work assignment decision. Examples of variables which may be used in the multi-variable assignment process include current wait time, service objective, skill preference, skill level, anticipated wait time, predicted wait time, etc.

### SUMMARY OF THE INVENTION

The Applicant has tackled the problem of improving the known work unit assignment methods.

In particular, concerning the method disclosed in EP 1 119 170, the Applicant has observed that a possible drawback is that no account is taken, in the assignment process, of a current workload of the agents, calculated taking in turn into account the nature of the work units, which in the practice may greatly vary: for example, executing a work unit may require much more efforts compared to another work unit.

According to a first aspect of the present invention, a method is provided, as set forth in appended claim 1, for the automatic assignment of work units to at least two agents, comprising:
assigning to the work unit a first attribute describing a ranking of the work units;
real-time calculating current workloads of the agents, wherein said calculating is based on a number of work units currently assigned to the agents and on the respective ranking; and
assigning the work unit based on the calculated current workloads of the at least two agents.

Other aspects of the present invention relate to a system comprising means adapted to carry out the steps of the method the first aspect, and to a computer program comprising instructions for carrying out the steps of the method when said computer program is executed on a computer.

### BRIEF DESCRIPTION OF THE DRAWINGS

The features and advantages of the present invention will be made apparent by the following detailed description of an embodiment thereof, provided merely by way of non-limitative example, description which will be made in conjunction with the attached drawing sheets, wherein:

FIG. 1 pictorially shows a system for the automatic assignment of work units to agents in a call center, according to an embodiment of the present invention;

FIG. 2 schematically shows, in terms of functional blocks, the main components of a computer programmable to implement an automatic assignment method according to an embodiment of the present invention;

FIG. 3 schematically shows a profile of a generic agent;

FIG. 4 schematically shows a partial content of a working memory of the computer of FIG. 2 while carrying out a method according to an embodiment of the present invention for the automatic assignment of work units; and

FIG. 5 is a schematic flowchart illustrating some of the steps of an automatic work unit assignment method according to an embodiment of the present invention.

### DETAILED DESCRIPTION OF THE PREFERRED EMBODIMENTS

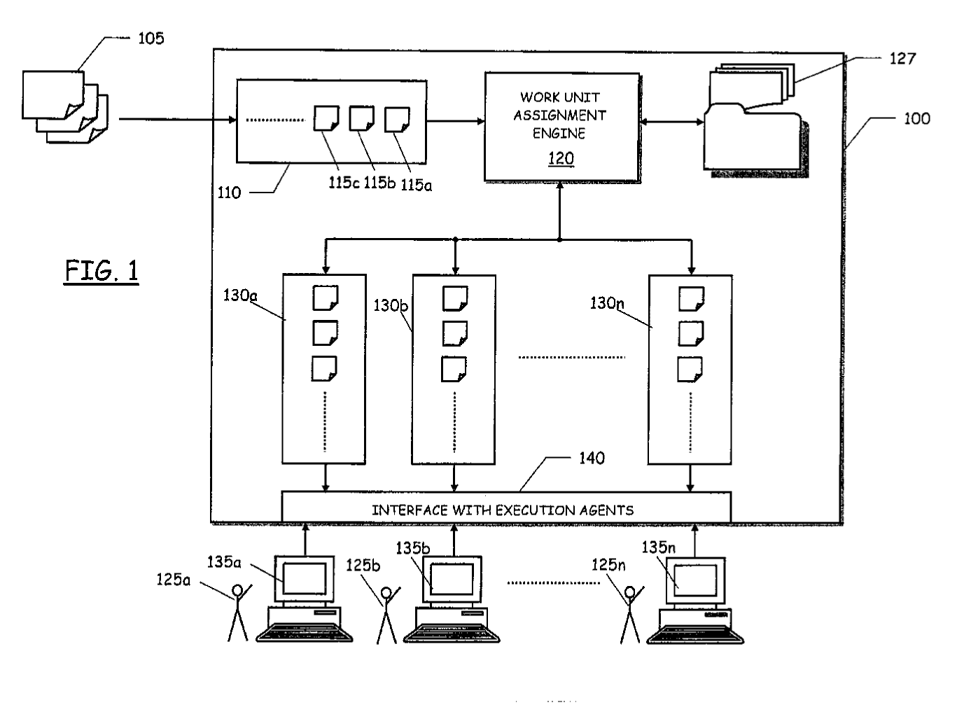

With reference to the drawings, in FIG. 1 a system 100 is shown for the automatic assignment of work units to agents in a call center, according to an exemplary and non-limitative embodiment of the present invention.

In particular, and just by way of example, the automatic assignment system 100 may represent a call center, set up by, or acting on behalf of, e.g., a manufacturing company (e.g., a company active in the Information Technology-IT-field), whereat calls from customers of the company are received. It is to be understood that the term “call center” as used in the present description has to be construed broadly; in particular, the calls that the call center is adapted to receive from the customers, corresponding to requests of resolution of problems (PMR), may be or include one or more among telephone calls, e-mail messages, SMS messages, files containing error logs generated by an application software while operating and submitted automatically by the application on-line. In other words, the call center 100 is a “generalized call center”, possibly but not limitatively relying on human operators to attend telephone calls from the customers. The specific way the PMRs are submitted and received at the call center 100 is not critical nor limitative to the present invention. In the drawing, reference numeral 105 designates a generic flow of incoming PMRs, regardless of their nature and how they are submitted to the call center 100.

As they are received, the PMRs are put into a queue 110, wherein the received PMRs 115a, 155b, 115c, . . . are for example ordered by their arrival time.

The PMRs waiting in the queue 110 to be served correspond to work units, which have to be assigned to agents for their execution. A generic work unit is described by attributes, that are adapted to identify the nature of the work unit, as described in greater detail later on.

A work unit assignment engine 120 automatically assigns the work units corresponding to the PMRs waiting in the queue 110 to selected ones among a plurality of agents 125a, 125b, 125n, based on predefined assignment criteria, described in detail in the following. The work unit assignment engine 120 is adapted to carry out the automatic work unit assignment based on the attributes of the work units, and on a collection 127 of agent profiles, wherein information useful for automatically assigning the work units to selected agents according to the predefined criteria are stored.

In particular, in an embodiment of the present invention, a plurality of agent work unit queues 130a, 130b, . . . , 130n, one queue in respect of each of the agents 125b, . . . , 125n are provided, and the work unit assignment engine 120 is adapted to automatically put a generic work unit into one of the plurality of agent work unit queues 130a, 130b, . . . , 130n. The agents may interface with the system 100, so as to look at the respective work unit queue 130a, 130b, . . . , 130n and determine the PMRs they have been assigned to, for example through respective data processing devices or terminals 135a, 135b, . . . , 135n that are connected to the system 100 through any suitable communication link (e.g., a LAN) and can colloquiate with the system 100 through a system interface 140.

The automatic assignment system 100 is or includes a data processing apparatus, like a personal computer, a workstation, a mainframe, which among other possible activities carries out the automatic work unit assignment. The general structure of the data processing apparatus (hereinafter, computer) of the automatic assignment system 100 is schematically shown in FIG. 2, with several functional units connected in parallel to a data communication (e.g., a PCI) bus 203. In particular, a Central Processing Unit (CPU) 205, typically comprising a microprocessor (possibly, a plurality of cooperating microprocessors), controls the operation of the computer, a working memory 207, typically a RAM (Random Access Memory) is directly exploited by the CPU 205 for the execution of programs and for the temporary storage of data during program execution, and a Read Only Memory (ROM) 209 is used for the non-volatile storage of data, and stores for example a basic program for the bootstrap of the computer, as well as other data. The computer comprises several peripheral units, connected to the bus 203 by means of respective interfaces. Particularly, peripheral units that allow the interaction with a human user are provided, such as a display device 211 (for example a CRT, an LCD or a plasma monitor), a keyboard 213 and a pointing device 215 (for example a mouse). The computer also includes peripheral units for local mass-storage of programs (operating system, application programs) and data, such as one or more magnetic Hard-Disk Drivers (HDD), or DASDs (Direct Access Storage Devices), globally indicated as 217, driving magnetic hard disks, a CD-ROM/DVD driver 219, or a CD-ROM/DVD juke-box, for reading/writing CD-ROMs/DVDs. Other peripheral units may be present, such as a floppy-disk driver for reading/writing floppy disks, a memory card reader for reading/writing memory cards, a Universal Serial Bus (USB) adapter with one or more USB ports, printers and the like. For the connection to a data communication infrastructure 250, the computer may be further equipped with a Network Interface Adapter (NIA) card 221; alternatively (or in addition), the computer may be connected to a data communication infrastructure 250 by means of a MODEM, not explicitly depicted in the drawing.

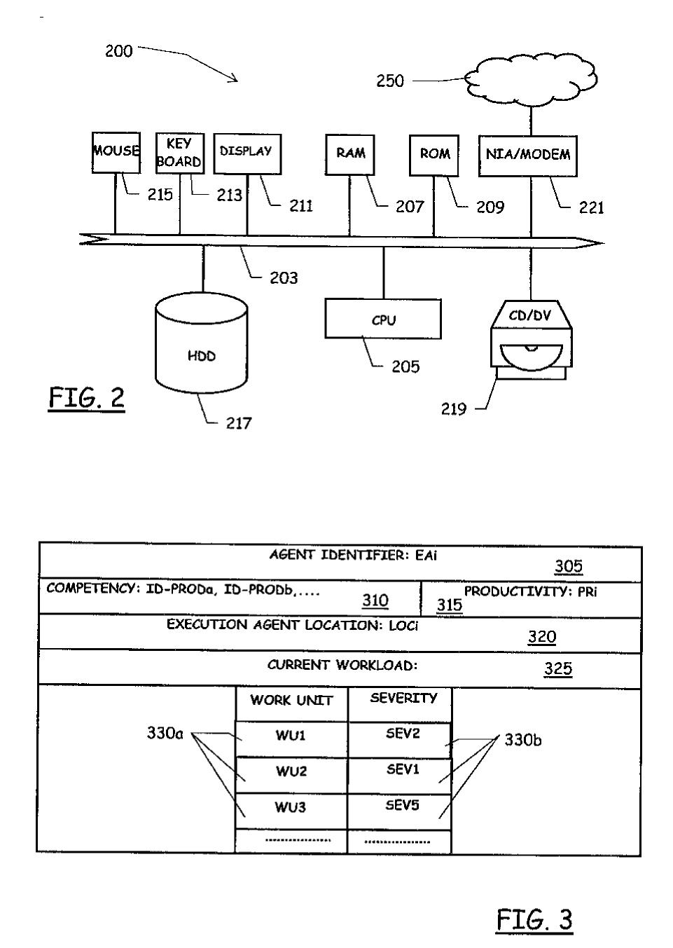

As mentioned in the foregoing, the automatic work unit assignment method according to an embodiment of the present invention is based on predefined criteria, for the application of which attributes describing the work units to be assigned, and information stored in the profiles of the agents are exploited. FIG. 3 schematically shows a content of an exemplary agent profile. The data of the agent profile are for example arranged in fields, and include for example a field 305 specifying an agent identifier, a field 310 wherein information adapted to determine the competency of the agent is stored, a field 315 specifying a productivity rate of the agent; a field 320 specifying a physical location of the agent; and a field or set of fields 325 specifying the current workload of the agent. In particular, the productivity rate may for example be a number ranging from 0 to 1 and expressing a productivity of that agent with respect to a reference productivity; for example, a full time, full-trained (i.e., skilled) agent may have a productivity rate equal to 1 (100%), whereas a part-time, full-trained agent may have a lower productivity rate, equal for example to 0.8 (80% of the productivity of the full-trained, full time agent), and a part-time agent may have an even productivity lower rate, equal to 0.5 (50% of the productivity of a full-trained, full-time agent). The physical location indication may be useful in case of delocalization of the agents with respect to the call center, or when the agents, for the resolution of the PMRs, have to physically go to the customers' premises. The competency of the agent may be specified as one or more identifiers of tasks (e.g., software and/or hardware products and/or services) for which that agent is competent. The workload may be specified in terms of a list 330a of work units currently assigned to that agent; preferably, each work unit is assigned an attribute, i.e. descriptor 330b describing a level of severity thereof. The level of severity may be an indication of how complex the resolution of that work unit is, and/or an indication of a level of urgency of that work unit. For example, five different levels of severity may be defined, from 1 to 5, the level 1 corresponding to the work units having the highest severity (and thus the more complex and/or the most urgent).

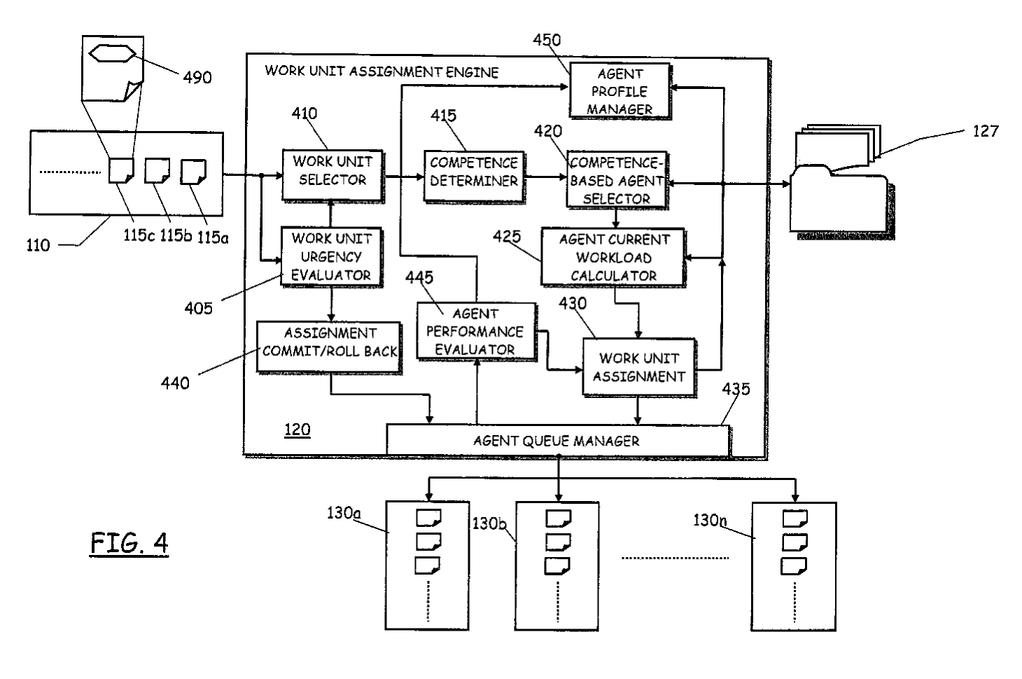

FIG. 4 is a schematic representation of a partial content of the working memory of the computer of the call center programmed to execute a program implementing an automatic work unit assignment method according to an embodiment of the present invention. The programs are installed on the computer's hard disk, and, when launched, are at least partially loaded in the computer working memory; FIG. 4 does not explicitly show a computer operating system, hardware-dependent drivers, and other components that are not essential to the understanding of the invention embodiment described but are usually present. A work unit urgency evaluator module 405 is adapted to evaluate the urgency of the different work units waiting at a certain time in the queue 110, so as to determine for example the most urgent one. The urgency evaluator module 405 is in particular adapted to determine the urgency of a work unit based on the attributes 490 thereof, which include for example the previously mentioned level of severity (as mentioned, the level of severity may be an indication of the urgency of the work unit and/or of the complexity thereof), an indication of the type of competency(ies), i.e. of skills, required for solving the PMR (for example, the identifier of the product to which the PMR relates), an indication of the location of the customer. The work unit attributes may be included in the corresponding incoming PMR, or derived automatically by the work unit assignment system upon receipt of the PMR, based on the information which the customers are asked to provide upon compiling a PMR to be submitted to the call center.

A work unit selector module 410 is adapted to select the work units from the queue 110, based for example on an indication of urgency received from the urgency evaluator module 405. The work unit selector module 410 passes the selected work units to a competence determiner module 415, adapted to determine which competence is required to perform the tasks involved in the selected work unit, based on the attributes of the work units. A competence-based agent pre-selector module 420 is adapted to perform a first selection among all the possible agents based on the required competence determined by the competence determiner module 410, and exploiting the information (field 310) available in the agents' profiles 127. An agent current workload real-time calculator module 425 is adapted to calculate in real-time the current workloads of the agents of the group selected by the competence-based agent pre-selector module 420, exploiting the information contained in the agent profiles. A work unit assignment module 430 is adapted to assign the work units to the agents based on the results of the workload calculator module 425, and possibly of other information contained in the work unit attributes and in the agent profiles, like for example the location of the customer and of the agents. A queue manager module 435 is adapted to put the work units into the queues 130a, 130b, . . . , 130n of the agents to which the work units are assigned. According to an embodiment of the present invention, the assignment of the work units to the agents is performed according to a two-step procedure: the work unit are firstly tentatively assigned to the agents, and then the assignment is committed, i.e. confirmed and made definitive, or alternatively rolled back, and a new assignment procedure is performed; to this purpose, a work unit assignment commit/roll back module 440 is adapted to confirm the assignment, or to cause a roll back to a previous situation. An agent performance evaluator module 445 is adapted to evaluate the performance of the agents in executing the tasks assigned thereto. The evaluated performance may be used to update the agent profiles, through a manager module 450.

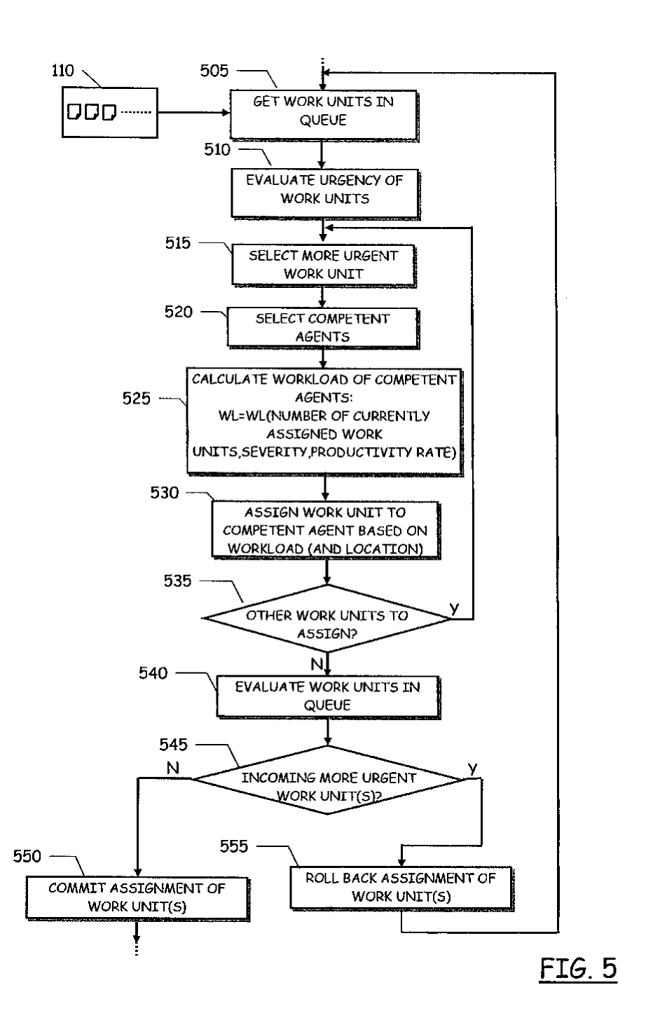

An assignment method according to an embodiment of the present invention will be now described in detail, with the help of the schematic flowchart of FIG. 5.

The work unit assignment engine 120 checks the queue 110 of incoming PMRs for ascertaining the presence therein of work units to be assigned to agents; this may be an action that the work unit assignment engine 120 performs periodically, with a predetermined periodicity, and/or upon arrival of a PMR having high severity, i.e. an urgent PMR, having severity level higher than a predetermined threshold, e.g. 3. The work unit urgency evaluator module 405 gets the work units in the queue 110 (block 505), determines the respective urgency (block 510), looking for example at their severity level, and sorts the work units by decreasing urgency, i.e., in the example herein considered, by decreasing severity level.

The work unit selector module 410 then selects the more urgent work unit among those waiting in the queue 110 (block 515). The competence determiner module 415, based on the attributes of the selected work unit, determines which competence is required to execute the work unit, and the competence-based agent selector module 420 selects the agents having that competency(ies) (block 520); the selection is made on the basis of the competence information contained in the agents profiles. The agents not having the required competency(ies) are not selected; in this way, a sub-set of the available agents is in general created, including the agents having the required competency(ies).

The agent current workload real-time calculator module 425 then calculates in real-time the current workload of the competence-based selected agents (block 525).

In particular, according to an embodiment of the present invention, the calculation of the current agents' workload is made on the basis of the number of work units currently assigned to the generic agent, on their severity level, and on the productivity rate of the agent. All this data, exploited to calculate the current workload, are for example contained in the agent profiles. For example, the following formula can be used to calculate the current workload of the generic i-th agent:

$${}_{i} {WL}_{i} = \frac{\sum \# {WU}_{k} * {SEV}_{k}}{{PROD}_{I}}$$

wherein #WUₖ is the number of work units of severity level k (k =1, 2, 3, 4, 5, for example) currently assigned to the i-th agent, SEVk is a weight factor associated with the generic k-th level of severity, and PRODᵢ is the productivity rate, which, as mentioned in the foregoing, is for example a number from 0 to 1 describing the productivity of the i-th agent compared to the productivity of a full-time, full-trained agent.

Based on the calculated current workloads, the work unit is assigned to a selected one among the competent agents (block 530); for example, the work unit may be assigned to the agent currently having the lowest workload, among those having the required competency(ies).

In an alternative embodiment of the present invention, a maximum workload may be set, either unique for all the agents, or specific of each agent, and the maximum workload may be included in the agent profile. In the work unit assignment, the resultant projected workload on the agents, resulting from the real time calculation of the workloads that would result from the assignment of that work unit to the agents, may be calculated, and, if for one or more agents the projected workload exceeds the maximum workload, that or those agents are not assigned the work unit; the work unit may for example be assigned to the agent for which the difference between the projected workload and the maximum workload is highest.

When relevant, the location of the agents may also be taken into account in the work unit assignment decision: for example, the indication about the location of the agent may be combined with the run-time calculated current workload, so that, in case two (or more) agents have substantially a same workload, the agent whose location is closer to that of the customer is selected. In particular, and just by way of example, the severity levels of the work units may be used as weight factors for weighting the location of the agents, so that for more urgent work units, agents being located closer to the customer are preferred in the work unit assignment.

Other, additional criteria may be taken into account in assigning the work units. For example, exploiting an indication of resolution time needed to solve a PMR of a certain severity level (for example, PMR average resolution times may be calculated at the level of the call center, based on the historical data), an expected PMR resolution time is calculated (as the current time plus the average resolution time for that severity level); the agents whose regular working time will not end before the expected resolution time may be preferred in the assignment procedure.

As a further possibility, when all the agents having the required competency(ies) have excessive workloads, the assignment engine 120 may try to assign the work unit to an agent who, albeit not matching at best the competence criterion, currently has a low(er) workload.

After having assigned the work unit, the next work unit in order of urgency is then selected (block 515), if any remain to be assigned (decision block 535, exit branch Y), and the assignment procedure is repeated.

When no more work units remain to be assigned (exit branch N of decision block 535), the assignment engine 120 evaluates whether, while carrying out the work unit assignment, new work units, corresponding to successively incoming PMRs, have entered the queue (block 540). In case during the assignment procedure no urgent work units have entered the queue 110 (exit branch N of decision block 545), the assignment is committed (block 550), i.e. the assignment of the work units to the queues 130a, 130b, . . . , 130n of the agents is confirmed and consolidated. If instead during the assignment procedure more urgent work units have entered the queue 110 (exit branch Y of decision block 545), the assignment is not committed, and the situation is rolled back to the initial situation (block 555). By more urgent work units may mean work units whose severity level exceeds a predetermined threshold, e.g. is equal or higher than 2, and/or work units corresponding to PMRs received from particular categories of customers for which a preferential treatment is reserved. The assignment procedure is restarted from the beginning, so that the assignment takes into account the newly arrived, urgent work unit(s).

Thanks to the method according to the described embodiment of the present invention, agents do not have to waste precious time in selecting the PMRs to be serviced: the assignment is made automatically.

The assignment is balanced, because it is based on a real-time evaluation of the current agent workloads.

The commit/roll back feature allows to duly take into account the possibility that, while assigning work units, a more urgent work units has arrived.

The Applicant believes that thanks to the automatic work unit assignment method of the present invention will improve the overall responsiveness of the call center.

In a way similar to that followed for the real-time calculation of the workload, a score may be calculated for each agent; for example, taking a reference period of time, like for example one year, an agent score is calculated by a summation of all the work units handled in that period, each work unit weighted by a respective weight factor, for example corresponding to the severity thereof. The result obtained is by far more significant that a mere overall number of work units handled, because account is taken of the level of complexity and/or urgency thereof. The score may also be exploited for adjusting the productivity rate of the agent, in this may making the assignment system adaptive. In other words, by taking into account not only the number, but also the nature, particularly the complexity and/or urgency of the work units that a certain agent executed in the reference period, a more objective evaluation of the agent efficiency is achieved.

Although the present invention has been described by way of an embodiment, it is apparent to those skilled in the art that several modifications to the described embodiments, as well as other embodiments of the present invention are possible without departing from the scope thereof as defined in the appended claims.

For example, one or more list of “premium” customers may be established, for example customers having subscribed specific service agreements. The PMRs received by these customers may be assigned predetermined, minimum level of severity, i.e. of urgency, so that the requests from these customers are given a sort preferential lane.

Also, in the assignment of the work units account may be taken of the past assignments of work units coming from that customer to a certain agent, in order to create a “familiarity” that is believed to improve the trust of the customer in the capabilities of the call center.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of the present description, a computer-usable or computer-readable medium can be any apparatus, device or element that can contain, store, communicate, propagate, or transport the program for use by or in connection with the computer or instruction execution system.

The medium can be an electronic, magnetic, optical, electromagnetic, infrared, or semiconductor storage medium, network or propagation medium. Examples of a storage medium include a semiconductor memory, fixed storage disk, moveable floppy disk, magnetic tape, and an optical disk. Current examples of optical disks include compact disk—read only memory (CD-ROM), compact disk—read/write (CD-R/W) and digital versatile disk (DVD). Examples of a propagation medium include wires, optical fibers, and wireless transmission.

The invention can be applied in a data processing system having a different architecture or based on equivalent elements; each computer can have another structure or it can be replaced with any data processing entity (such as a PDA, a mobile phone, and the like).

1. A method for the automatic assignment of a work unit to one of at least two agents for the execution thereof, comprising:
assigning to the work unit a first attribute adapted to indicate a ranking among the work units;
real-time calculating current workloads of the agents, wherein said calculating is based on a number of work units currently assigned to the agents and on the respective ranking; and
assigning the work unit based on the calculated current workloads of the at least two agents.

2. The method according to claim 1, wherein said attribute is adapted to indicate at least one among a degree of complexity of the work units and an urgency thereof.

3. The method according to claim 1, further comprising:
for each of said at least two agents, defining a respective productivity indication adapted to indicate a productivity of the agent,
wherein said calculating the current workload is further based on said productivity indication.

4. The method according to claim 3, wherein said productivity indication provides an indication of rapidity of the agent in executing the work units assigned thereto.

5. The method according to claim 4, wherein said productivity indication is determined based on at least one among a level of training of the agent and a working timetable thereof.

6. The method according to claim 1 further comprising:
assigning to the work unit a second attribute describing competencies required to the agents for executing the work unit;
providing a description of competencies of the at least two agents;
wherein said assigning the work unit is further based on a comparison of the competencies required for executing the work unit to the competencies of the agents.

7. The method according to claim 1 further comprising:
assigning to the work unit a third attribute describing a physical location whereto the agent has to go for executing the work unit,
providing a description of a current location of the at least two agents
wherein said assigning the work unit is further based on a comparison of said physical location with the current location of the agents.

8. The method according to claim 1 further comprising:
placing incoming work units into a queue;
ranking the work units that are in the queue at a predetermined time instant based on the first attribute;
assigning the work units to the agents based on said ranking;
after said assigning, evaluating whether at least one new work unit has entered the queue after said ranking,
in the negative case, consolidating the assignment of the work units to the agents;
in the affirmative case, rolling back the assignment and performing again said ranking and said assigning taking into account the at least one new work unit in case the latter has a ranking higher than a predetermined threshold.

9. The method according to claim 1 further comprising;
calculating, for each of the at least two agents, a respective score based on a number of work units executed in a predetermined period of time, taking into account the respective ranking.

10. A system for the automatic assignment of a work unit to one of at least two agents for the execution thereof, comprising:
means for assigning to the work unit a first attribute adapted to indicate a ranking among the work units;
means for real-time calculating current workloads of the agents, wherein said calculating is based on a number of work units currently assigned to the agents and on the respective ranking; and
means for assigning the work unit based on the calculated current workloads of the at least two agents.

11. A computer product in a computer readable medium for the automatic assignment of a work unit to one of at least two agents for the execution thereof, comprising:
instructions for assigning to the work unit a first attribute adapted to indicate a ranking among the work units;
instructions for real-time calculating current workloads of the agents, wherein said calculating is based on a number of work units currently assigned to the agents and on the respective ranking; and
instructions for assigning the work unit based on the calculated current workloads of the at least two agents.
